(19) United States
(12) Patent Application Publication
(10) Pub. No.: US 2009/0113005 A1
(43) Pub. Date: Apr. 30, 2009

(54) Systems and methods for controlling pre-communications interactions

(76) Inventors: Justin Gregg, San Francisco, CA (US); Casey Dougherty, San Francisco, CA (US); Michael M. Lee, San Jose, CA (US); Ashwin Sunder, Palo Alto, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/981,866

(22) Filed: Oct. 31, 2007

(51) Int. Cl. G06F 15/16

(52) U.S. Cl. 709/206

(57) ABSTRACT

The present invention can permit a communications request initiator to control pre-communications interactions. For example, the present invention can permit a communications request initiator to instruct a recipient communications device to present specific information to a communications request recipient when the initiator sends the communications request to the recipient. The present invention also can permit a communications request initiator to control the information presented to the initiator when he is waiting for a communications request recipient to respond to the communications request.

### FIELD OF THE INVENTION

The present invention relates to systems and methods for controlling pre-communications interactions. More particularly, the present invention can permit an initiator of a communications request to control pre-communications interactions.

### BACKGROUND OF THE INVENTION

Many cell phone users enjoy customizing ringtones. A cell phone user can assign specific ringtones (e.g., songs) to people in the user's electronic address book. When a caller for whom a custom ringtone has been assigned calls the user (i.e., the call recipient), the user's cell phone alerts the user to the incoming call by playing the custom ringtone assigned to that caller. This can assist the call recipient in identifying the caller before the call recipient answers the call. A cell phone user also can assign a specific ringtone to replace the standard ringtone that callers hear when they call the user (i.e., a reverse ringtone). Thus, a caller can be entertained by the non-standard ringtone while the caller is waiting for the call recipient to answer.

However, these customization models place control of ringtone selection in the hands of the call recipient. The caller has no direct control over the information used to alert the call recipient as to the caller's identity nor does the caller have control over the information presented to him while he is waiting for the call recipient to answer.

### SUMMARY OF THE INVENTION

Systems and methods are provided for controlling pre-communications interactions.

The present invention can permit an initiator of a communications request to control the information is used to alert the communications request recipient of the incoming request. For example, a user can send a recipient communications device (e.g., a recipient cell phone) an electronic personal data file (e.g., a vcard) having one or more associated information assets (e.g., a specific ringtone) and a signature to identify the user as the initiator of a communications request (e.g., a cell phone number). The next time the user initiates a communications request to the recipient device, the recipient device can match the signature to data from the communications request and alert the recipient device user of the incoming communications request using information related to the initiating user's information assets (e.g., by playing the ringtone selected by the initiating caller). This can assist the recipient user in identifying the initiating user as the initiator of the communications request. Thus, rather than providing the recipient user with sole control over selecting the information used to identify the initiator, the present invention can permit the initiator to also have control.

The present invention also can permit an initiator of a communications request to control the information presented to him while he is waiting for the communications request recipient to respond to the request. For example, a user can send a recipient communications device (e.g., a recipient cell phone) an electronic personal data file (e.g., a vcard) having one or more associated information assets (e.g., a specific ringtone) and a signature to identify the user as the initiator of a communications request (e.g., a cell phone number). The next time the user initiates a communication request to the recipient device, the recipient device can match the signature to data from the communications request and cause the initiating user to be presented with information related to the initiating user's information assets while the initiating user is waiting for the recipient to respond to the communications request (e.g., by being presented with the ringtone selected by the initiating caller).

### BRIEF DESCRIPTION OF THE DRAWINGS

The above and other advantages of the present invention will be apparent upon consideration of the following detailed description, taken in conjunction with accompanying drawings, in which like reference characters refer to like parts throughout, and in which:

FIG. 1 is an illustrative block diagram of a communications system in accordance with one embodiment of the present invention;

FIG. 2 is an illustrative communications device in accordance with one embodiment of the present invention;

FIG. 3 is an illustrative flowchart of a process performed by a communications device for associating information assets to an electronic personal data file in accordance with one embodiment of the present invention;

FIG. 4 is an illustrative flowchart of a process performed by a recipient communications device for accepting and storing an electronic personal data file sent from another communications device in accordance with one embodiment of the present invention;

FIG. 5 is an illustrative flowchart of a process performed by a recipient communications device for accepting an incoming communications request and activating information assets based on the request in accordance with one embodiment of the present invention;

FIG. 6 is an illustrative flowchart of a process performed by a recipient communications device to activate an information asset in accordance with one embodiment of the present invention; and

FIG. 7 is an illustrative flowchart of a process performed by a central server network responsive to activation of an information asset by a recipient communications device in accordance with one embodiment of the present invention.

### DETAILED DESCRIPTION OF THE INVENTION

Current communications systems permit a recipient of a communications request to control pre-communications interactions. For example, as discussed above, a cell phone user can assign specific ringtones to people in his electronic address book. When one of the people in the electronic address book later calls the user (i.e., the call recipient), the cell phone will play the ringtone the user assigned to that caller. Likewise, a cell phone user can assign a specific ringtone to be played to callers when the callers are waiting for the user (i.e., the call recipient) to answer. These models place control of pre-communications interactions in the hands of the call recipient, not in the hands of the call initiator.

The present invention can shift this paradigm by placing control of pre-communications interactions in the hands of the communications request initiator. For example, the present invention can permit a communications request initiator to instruct a recipient communications device to present specific information to a communications request recipient when the initiator sends a communication request to the recipient. The present invention also can permit a communications request initiator to control the information presented to the initiator when he is waiting for a communications request recipient to respond to the communication request.

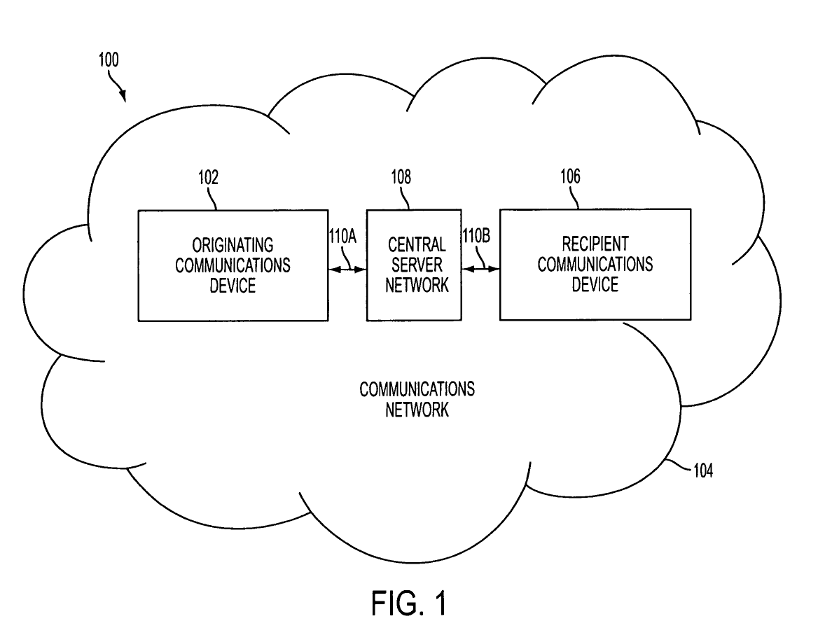

FIG. 1 is an illustrative block diagram of a communications system in accordance with one embodiment of the present invention. Communications system 100 can include a communications device that initiates an outgoing communications request (originating communications device 102) and communications network 104, which originating communications device 102 can use to initiate and conduct communications operations with other communications devices within communications network 104. For example, communications system 100 can include a communications device that receives the communications request from the originating device (recipient communications device 106).

Communications system 100 also can include central server network 108. Central server network 108 can include any hardware and/or software needed to facilitate pre-communications interactions between originating and recipient devices 102 and 106 in accordance with the present invention. Central server network 108 also can include any hardware and/or software needed to facilitate communications interactions between the devices once a communications link has been established. In some embodiments or steps of the present invention, the central server network may not be needed (e.g., in peer-to-peer networks or transfers).

As used herein, the term “originating communications device” means a communications device that initiates a communications request. The term “recipient communications device” means a communications device to which a communications request is targeted. The term “pre-communications interactions” means interactions facilitated by multiple communications devices after one or more communications requests has been transmitted but before one or more communications links is established. Although communications system 100 may include several originating devices 102 and recipient devices 106, only one of each is shown in FIG. 1 to simplify the drawing.

Any suitable circuitry, software, device, system or combination of these (e.g., a wireless communications infrastructure including communications towers and telecommunications servers) operative to create a communications network may be used to create communications network 104. Communications network 104 may be capable of providing communications using any suitable communications protocol. In some embodiments, communications network 104 may support, for example, traditional telephone lines, cable television, WiFi (e.g., a 802.11 protocol), Bluetooth™, high frequency systems (e.g., 900 MHz, 2.4 GHz, and 5.6 GHz communication systems), infrared, other relatively localized wireless communication protocol, or any combination thereof. In some embodiments, communications network 104 may support protocols used by wireless and cellular phones and personal email devices (e.g., a Blackberry®). Such protocols can include, for example, GSM, GSM plus EDGE, CDMA, quadband, and other cellular protocols. In another example, a long range communications protocol can include WiFi and protocols for placing or receiving calls using VOIP or LAN. When communications network 104 supports a combination of different types of communications protocols, central server network 108 also may include servers to support the different types of protocols.

Originating communications device 102 and recipient communications device 106, when located within communications network 104, may communicate over bidirectional communication paths such as paths 110A and 110B. Both originating device 102 and recipient device 106 may be capable of initiating a communications request and receiving an initiated communications request. Communication paths 110A and 110B can support wireless communication, wired communication, or a combination of both. For example, originating device 102 (e.g., a telephone connected to a landline) can communicate over a wired communication path 110A, while recipient device 106 (e.g., a cell phone) can communicate over a wireless communication path 110B.

Originating device 102 and recipient device 106 can include any suitable device for sending and receiving communications requests, and participating in communications interactions. For example, communications devices 102 and/or 106 may include a media player such as an ipod available from Apple Inc., of Cupertino, Calif., a cellular telephone or a landline telephone, a personal e-mail or messaging device (e.g., a Blackberry® or a Sidekick®), an iphone available from Apple Inc., pocket-sized personal computers such as an iPAQ Pocket PC available by Hewlett Packard Inc., of Palo Alto, Calif., personal digital assistants (PDAs), a desktop computer, a laptop computer, or any other device capable of communicating wirelessly (with or without the aid of a wireless enabling accessory system) or via wired pathways (e.g., using traditional telephone wires). The communications operations may include any suitable form of communications, including, for example, voice communications (e.g., telephone calls), data communications (e.g., e-mails, text messages, media messages), or combinations of these (e.g., video conferences). Also, originating communications device 102 and recipient communications device 106 may be different types of communications devices. For example, originating device 102 can be a laptop computer and recipient device 106 can be a cell phone. The laptop can establish a communications link with the cell phone using VOIP and the GSM network.

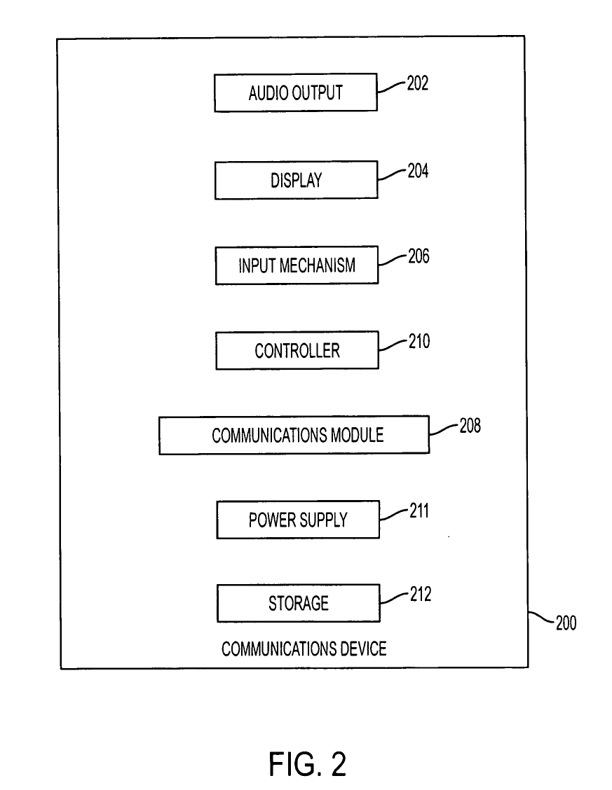

FIG. 2 is an illustrative communications device in accordance with one embodiment of the present invention. Both originating device 102 (FIG. 1) and recipient device 106 (FIG. 1) can include some or all of the features of communications device 200. Communications device 200 may include audio output 202, display 204, input mechanism 206, communications module 208, controller 210, power supply 211, storage 212, and any other suitable components. In addition to audio output 202 and display 204, communications device 200 can include other output mechanisms, e.g., hardware to cause the device to vibrate. One or more of these components may reside remotely. For example, the communications module, storage, and/or controller can reside wholly or partially on a remote server configured to assist in communications interactions. Each component of communications device 200 referenced herein may include one or more hardware units and/or software. All of the applications employed by audio output 202, display 204, input mechanism 206, communications module 208, power supply 211, and storage 212 can be interconnected and managed by controller 210.

Audio output 202 may include any suitable audio component for providing audio to the user of communications device 200. For example, audio output 202 may include one or more speakers (e.g., mono or stereo speakers) built into communications device 200. In some embodiments, audio output 202 may include an audio component that is remotely coupled to communications device 200 (e.g., a headset, headphones or earbuds that may be coupled to communications device 200 with a wire or wirelessly).

Display 204 may include any suitable screen or projection system for providing a display visible to the user. For example, display 204 may include a screen (e.g., an LCD screen) that is incorporated in communications device 200. As another example, display 204 may include a movable display or a projecting system for providing a display of content on a surface remote from communications device 200 (e.g., a video projector). Display 204 may be operative to display content (e.g., information related to pre-communications interactions or to the communications interactions themselves) under the direction of controller 210.

Input mechanism 206 may be any suitable mechanism for providing user inputs or instructions to communications device 200. Input mechanism 206 may take a variety of forms, such as one or more buttons, keypads, dials, trackballs, sliders, click wheels, touch screens, and/or microphones. The user interface may include a multi-touch screen such as that described in U.S. Pat. No. 6,323,846, which is incorporated by reference herein in its entirety. The user interface may emulate a rotary phone or a multi-button keypad, which may be implemented on a touch screen or the combination of a click wheel or other user input device and a screen. A more detailed discussion of such a rotary phone interface may be found, for example, in U.S. patent application Ser. No. 11/591,752, filed Nov. 1, 2006, entitled “Touch Pad with Symbols based on Mode,” which is incorporated by reference herein in its entirety.

Communications module 208 may be any suitable communications hardware (e.g., circuitry) and/or software operative to initiate a communications request, connect to a communications network (e.g., communications network 104, FIG. 1) and to transmit communications (e.g., voice or data) from communications device 200 to other devices within the communications network. Communications module 208 may be operative to interface with the communications network using any suitable communications protocol such as, for example, WiFi (e.g., a 802.11 protocol), Bluetooth™, high frequency systems (e.g., 900 MHz, 2.4 GHz, and 5.6 GHz communication systems), infrared, GSM, GSM plus EDGE, CDMA, quadband, and other cellular protocols, VOIP, or any other suitable protocol.

In some embodiments, communications module 208 may be operative to create a communications network using any suitable communications protocol. For example, communications module 208 may create a short-range communications network using a short-range communications protocol to connect to other devices. For example, communications module 208 may be operative to create a local communications network using the Bluetooth® protocol to couple communications device 208 with a Bluetooth® headset.

Controller 210 may be any suitable hardware (e.g., circuitry) and/or software operative to control the operations and performance of communications device 200. Controller 210 may include, for example, one or more processors, buses (e.g., for sending instructions to the other components of communications device 200), control software, or any other suitable component(s) for controlling the operations of communications device 200. In some embodiments, a processor may drive the display and process inputs received from input mechanism 206. Controller 210 can include one monolithic unit or multiple units (e.g., multiple processors) configured to work together to control the operations and performance of communications device 200.

Controller 210 may be operative to perform some or all of the operations of one or more applications implemented on communications device 200. Any suitable number or type of applications may be implemented. In some embodiments, communications device 200 may operate or assist in operating one or several applications operative to perform communications operations. For example, communications device 200 may operate or assist in operating a messaging application, a mail application, a telephone application, a voicemail application, an instant messaging application (e.g., for chatting), a fax application, a contacts management application, or any other suitable application for performing any suitable communications operation. The applications can be partially or wholly stored on the communications device and/or on a remote server. The applications also can be partially or wholly run by controller 210 and/or controller of a remote server. For example, the application can be a web-based email or instant messaging application accessible using a communications device of the present invention.

Storage 212 can store firmware (e.g., for device applications such as an operating system, user interface functions, and processor functions) and information related to other devices with which the communications device performs communications operations (e.g., saving recipient contact information). Storage 212 can include, for example, cache, Flash, ROM, and/or RAM. Storage 212 can include local and/or remote storage. For example, storage 212 can include both local ROM, RAM, and cache, and storage space on a remote server.

Communications device 200 may include any other component suitable for performing a communications operation. For example, communications device 200 may include ports or interfaces for coupling to a host device, a secondary input mechanism (e.g., an ON/OFF switch), or any other suitable component.

A user may direct communications device 200 to perform a communications operation using any suitable approach. As one example, a user may receive a communications request from another device (e.g., an incoming telephone call, an email or text message, an instant message), and may engage in a communications interaction by accepting the communications request. As another example, the user may initiate a communications interaction by transmitting a communications request to another device (e.g., dialing a telephone number, sending an email, typing a text message, or selecting a chat screen name and sending a chat request).

The following description illustratively may, in some embodiments, apply the present invention to voice communications, wherein the communications device also can be internet-capable (such as in an iphone). However, as discussed above, the present invention can be applied to any type of communications in which pre-communications interactions may occur.

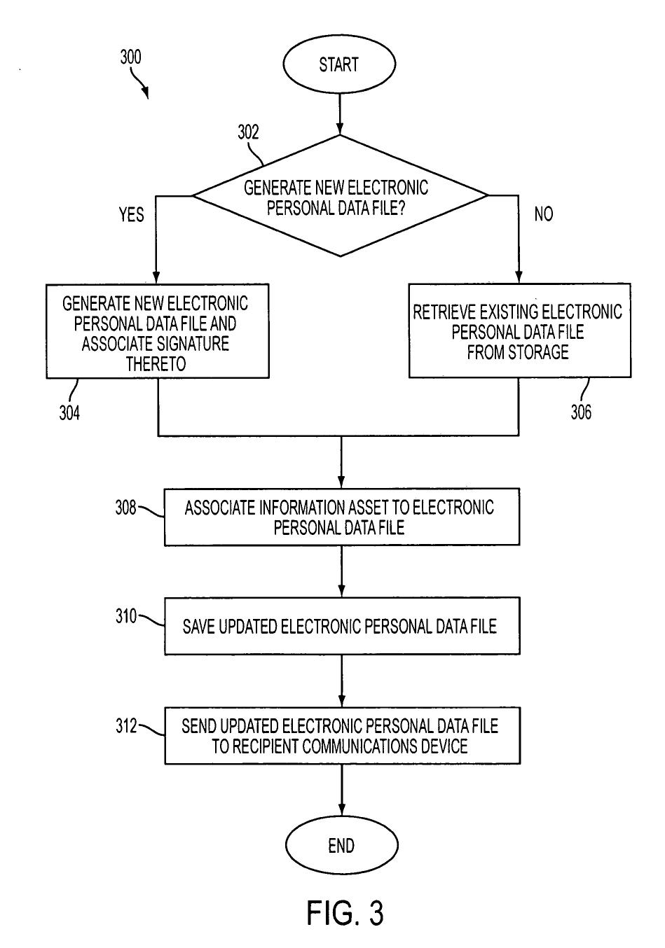

FIG. 3 is an illustrative flowchart of process 300 performed by a communications device for associating information assets to an electronic personal data file in accordance with one embodiment of the present invention. At step 302, a communications device can ask the user whether the user wants to generate a new electronic personal data file. As discussed in greater detail below, an electronic personal data file is a data file to which a user and/or communications device can associate one or more signatures and information assets. One example of an electronic personal data file is a vCard.

A signature can be information that a communications device can use to identify an initiator of a communications request. For example, such information can include names, contact information (e.g., cell phone number, other telephone number, email address, instant messenger address, fax number), identification codes for communication devices, and any other types of appropriate identification information. The signature can include a single entry of identification information or multiple entries. For example, in the latter case, the signature can include a cell phone number and an email address.

Information assets can be any information that a user (e.g., a communications request initiator) wants presented (e.g., to a communications request recipient or initiator) responsive to a communications request (e.g., sent by the initiator to the recipient). Information assets can include locally-stored files (files stored in storage 212 of the communications device) or remotely-stored files (files accessible through a network or central server). Information assets can include, for example, a ringtone (e.g., a standard ringtone, a song or portion thereof, a file of another audio genre, etc.), an image, a video, or a link thereto (e.g., a link to a remotely-stored media file from a media database such as iTunes offered by Apple Inc.). Information assets also can include, for example, a link to information on the internet (e.g., remotely-stored information on a peer-to-peer network). This allows information assets to include static information or dynamic information that may change over time.

In one embodiment of the present invention, the information asset can instruct a communications device to announce an incoming communications request using a user's voice (e.g., the voice of the communications request initiator). For example, the information asset can be instructions to the recipient device to use speech synthesis to generate such an announcement. For example, the recipient device can be instructed to analyze one or more voice samples recorded during one or more previous communications between the initiator and recipient, and then to generate an announcement based on the voice samples. Thus, when a recipient receives a communications request from a specific initiator with whom the recipient has previously spoken, the recipient's communications device can announce the communications request with the initiator's voice (e.g., saying “Hi, its me, Initiator. Pick up!”). The recipient device can generate the announcement either in real-time or immediately after it has sufficient voice samples to do so. In the latter case, the recipient device can save the generated announcement as an audio file. In an alternative embodiment, the initiator can record his own greeting and associate the resulting audio file with his electronic personal data file as an information asset before sending the data file to the recipient device. In a further embodiment of the present invention, the information asset can be a link to a greeting the initiator has recorded and stored on a remote server. This allows the initiator to change his greeting without having to resend his electronic personal data file.

In one embodiment of the present invention, the information asset also can be instructions or a link to instructions for the communications device to vibrate in a particular pattern, rather than or in addition to an audio and/or visual notification. For example, when the recipient communications device is a cell phone, the information asset can instruct the cell phone to vibrate in a specific pattern of varying frequencies, rather than in the standard vibration pattern with which cell phones can come pre-equipped.

The electronic personal data file also can include other types of information. For example, an electronic personal data file also can store comments and other personal information about a user. Once a user sends his electronic personal data file to a recipient communications device, the recipient user can change, add, or delete information associated with the data file.

If the user responds in the affirmative to step 302, at step 304, the communications device can generate a new electronic personal data file and associate a signature thereto. In one embodiment of the present invention, the communications device can automatically associate a signature to the data file, using, for example, default identification information. This can be desirable when the user intends the communications device performing process 300 to be the originating communications device for future communications with the recipient communications device. The communications device also can offer the user an opportunity to change the signature (e.g., amend, add, or delete entries). This can be desirable when the user does not contemplate using the communications device performing process 300 as the originating communications device for future communications with the recipient communications device, or does not contemplate using it as the sole originating device. Alternatively, the communications device also can be configured to ask the user whether the user wants to use a default signature or input a different signature. Alternatively, the communications device can be configured to ask the user to input a signature for association with the new electronic personal data file.

If the user responds in the negative to step 302, at step 306, the communications device can retrieve an existing electronic personal data file from storage. The existing electronic personal data file may already have a signature associated therewith. At this point, the communications device can ask the user whether the user wants to input a different signature or change the existing signature. However, if the retrieved data file does not already have an associated signature, the communications device can act to automatically associate a default signature to the file, ask the user to enter or change the signature, or a combination thereof as described above.

At step 308, the communications device can ask the user to associate one or more information assets to the electronic personal data file. For example, the user can associate a first information asset to be used to alert a communications request recipient of an incoming communications request, and a second, different information asset to be presented to the user when the user, acting as a communications request initiator, is waiting for the communications request recipient to respond to the request. Alternatively, the user can associate the same information asset for both functions. Once the user identifies the information assets, the assets are appropriately tagged to help a recipient communications device identify them, as described in greater detail below.

At step 310, the communications device can save the updated electronic personal data file in storage (e.g., storage 212 of FIG. 2). At step 312, the user can cause the communications device to transmit the updated electronic personal data file to a recipient communications device. This transfer can be accomplished using a peer-to-peer transfer or a server mediated transfer (e.g., using a central server).

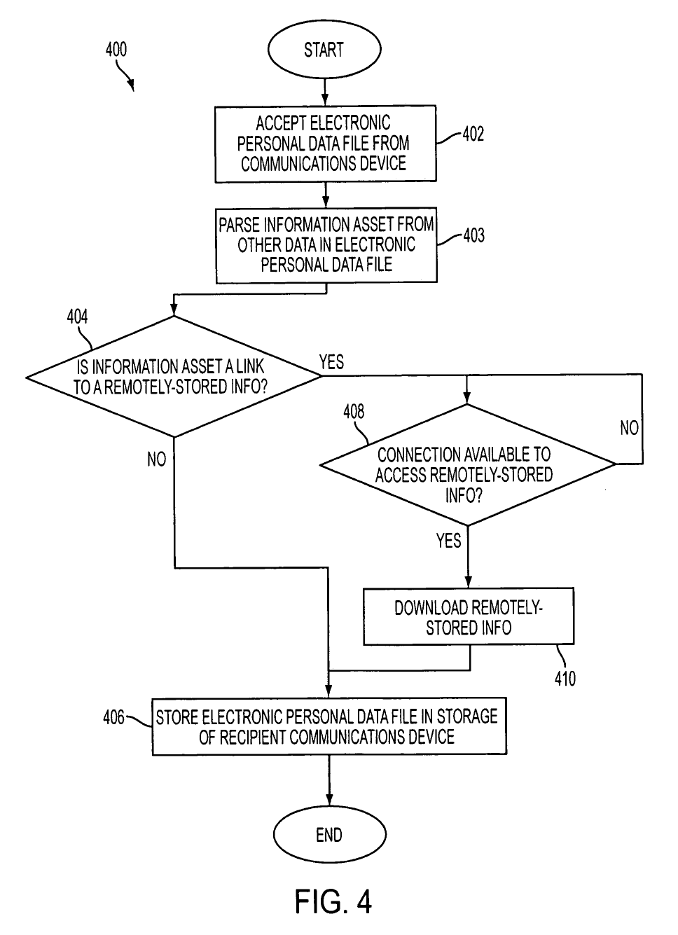

FIG. 4 is an illustrative flowchart of a process performed by a recipient communications device for accepting and storing an electronic personal data file sent from another communications device in accordance with one embodiment of the present invention. At step 402, the recipient communications device can accept an electronic personal data file transmitted from another communications device.

At step 403, the recipient device can parse the information asset(s) from other data associated with the electronic personal data file accepted in step 402. This can be accomplished by identifying the tags associated with the asset(s) in step 308 of FIG. 3.

At step 404, the recipient device can determine whether the information asset associated with the electronic personal data file is a link to remotely-stored information (e.g., a link to an iTunes media asset). If the answer is no, at step 406, the recipient device can store the electronic personal data file in a database. The database can be configured to store multiple electronic personal data files (e.g., an electronic address book).

However, if the answer is yes, at step 408, the recipient device can determine whether a connection (e.g., WiFi connection) is available to access the remotely-stored information. If not, the recipient device can try again periodically or the next time there is a synching operation between the device and a database in which the information is stored. For example, when the information asset is a link to an iTunes media file, the recipient device can try again the next time the device attempts a synching operation with iTunes. However, if the recipient device determines that there is a connection available, then it can download the remotely-stored information, and, in step 406, store the electronic personal data file, including the downloaded information asset.

The recipient device also can periodically update the downloaded information. This can be advantageous, for example, when the information asset is a link to dynamic information that may change over time. Thus, to ensure that users are presented with up-to-date information, the recipient device can periodically repeat one or more of steps 404-410.

In one embodiment of the present invention, recipient communications device can permit a user to override the information asset associated with an electronic personal data file. The recipient user can, for example, change the information asset associated with an electronic personal data to another information asset, examples of which are provided above. For example, when a call recipient and a caller enjoy different types of music, this permits the call recipient to change a ringtone that the caller assigned to the caller's electronic personal data file.

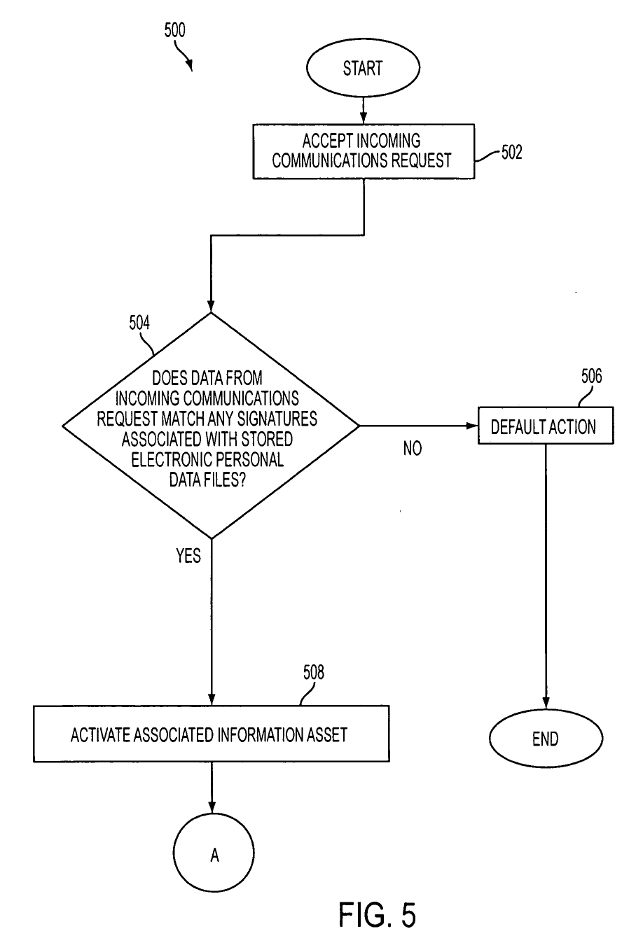

FIG. 5 is an illustrative flowchart of a process performed by a recipient communications device for accepting an incoming communications request and activating information assets based on the request in accordance with one embodiment of the present invention. At step 502, the recipient device can accept the incoming communications request.

At step 504, the recipient device can determine whether data from the incoming communications request matches any signatures associated with electronic personal data files stored in the recipient device's storage. If there is no match, the recipient device can take default action in step 506. For example, if the recipient device is an iphone, the iphone can alert a call recipient of an incoming call by playing a standard ringtone or a specific ringtone the user has assigned to be the default (e.g., a specific song). The iphone also can present a standard ringtone or specific default ringtone to the caller when the caller is waiting for the call recipient to answer. However, if there is a positive match, the recipient device then can identify the tagged information assets and thereafter automatically activate the information assets in step 508.

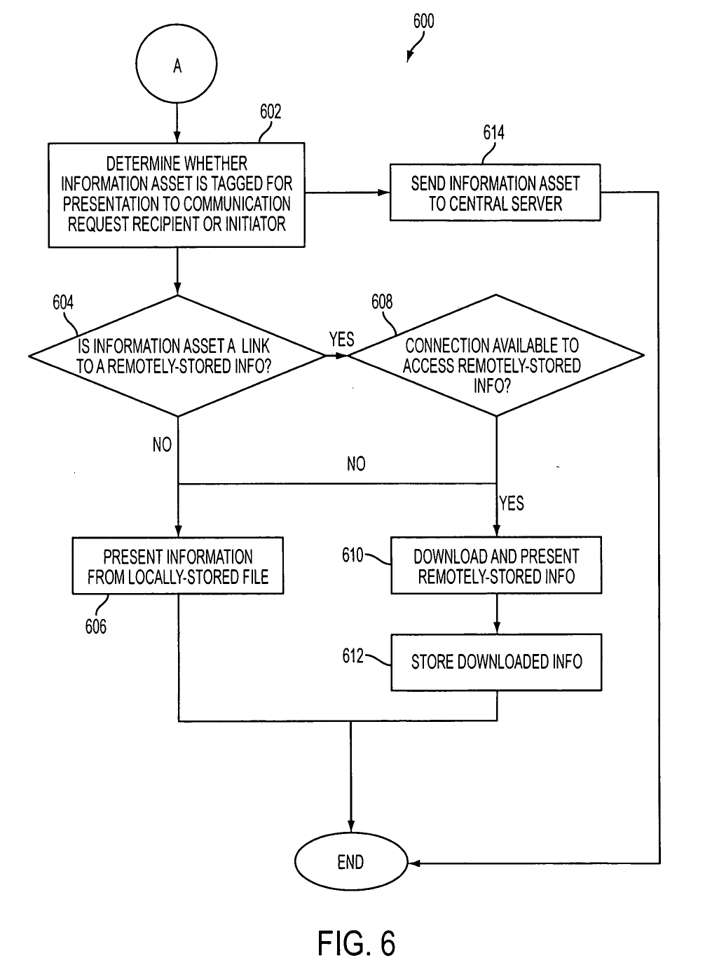

FIG. 6 is an illustrative flowchart of a process performed by a recipient communications device to activate an information asset in accordance with one embodiment of the present invention. At step 602, the recipient communications device can determine whether the information asset is tagged for presentation to the communications request recipient or the communications request initiator. If the information asset is tagged for presentation to the communications request recipient, the recipient device then can present the stored information asset to the recipient, thereby alerting the recipient to the incoming communications request. For example, if the communications request is a call request and the call initiator had assigned a specific ringtone as the information asset in step 308 of FIG. 3, the phone can present the call recipient with that specific ringtone selected by the call initiator.

In situations in which the communication request initiator selected the information asset to be a link to remotely-stored, dynamic information, it may be advantageous to download the remotely-stored information-again at this point in the process.

Accordingly, at step 604, the recipient device can determine whether the information asset is a link to remotely-stored information. If not, the recipient device can proceed to step 606, where it can present the locally-stored information to the communications request recipient to alert the recipient to the incoming communications request. But, if the information asset is a link to remotely-stored information, the recipient device can determine whether a connection is available to access the remotely-stored information at step 608. If not, the recipient device will proceed to step 606 and present the locally-stored version of the information that was downloaded at step 410 of FIG. 4. But, if a connection is available, the recipient device can download and present an updated version of the information at step 610. Thereafter, at step 612, the recipient device can store the updated information.

At step 602, if the recipient communications device determines that the information asset is tagged for presentation to the communications request initiator, the recipient device can transmit the information asset to a central server (e.g., central server network 108 of FIG. 1). That is, when the information asset is a locally-stored file, the recipient device can transmit that file to the central server. When the information asset is a link to remotely-stored information, the recipient device can transmit the link to the central server.

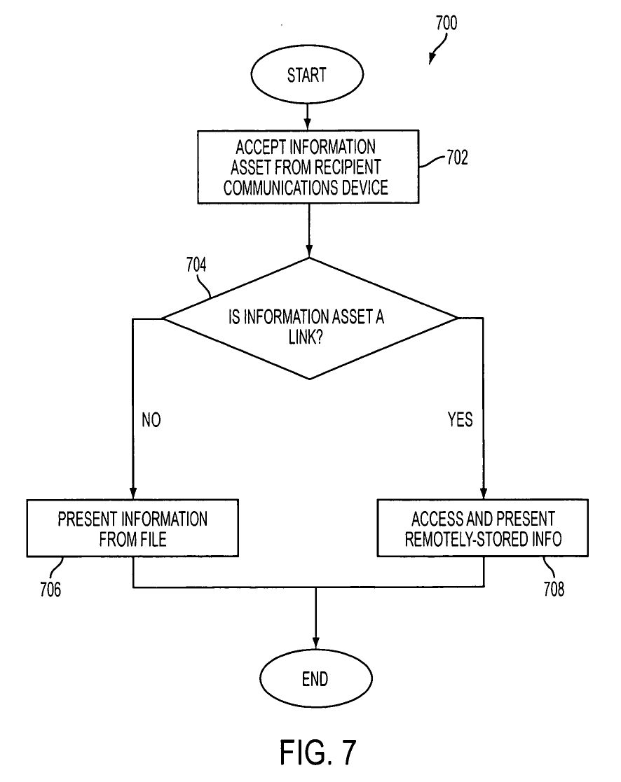

FIG. 7 is an illustrative flowchart of a process performed by a central server responsive to activation of an information asset by a recipient communications device in accordance with one embodiment of the present invention. At step 702, the central server (e.g., central server network 108) can accept the information asset from the recipient communications device. At step 704, the central server can determine whether the information asset is a link. If the information asset is a file, at step 706, the central server can present the information from the file to the communications request initiator while the initiator is waiting for the communications request recipient to respond to the request.

However, if the information asset is a link, the central server can access and present the information stored behind the link at step 708. The link can direct the central server to information stored on the central server itself, or to information stored on another remote server. For example, if the communications request is a call request and the initiator had (in step 308) assigned a link to an iTunes audio file as the information asset, the central server can access the iTunes database and stream the selected audio file to the call initiator while he is waiting for the call recipient to answer. In one embodiment of the present invention, the iTunes database can be stored on a server separate from the central server.

In accordance with one aspect of the present invention, information assets can have digital rights management protection. For example, although in some embodiments of the present invention an information asset can be locally-stored on the recipient communications device, the user of the recipient device would not own the asset nor be able to use that information asset for a purpose other than described above, unless the user also acquires rights to it. Rather, the rights to more freely use that information asset could belong solely to the user who originally purchased those rights. Rights to use an information asset can be acquired by paying for use, conceding to use the information asset in a certain manner, or without any payment or concession (free of charge).

While the above embodiments describe recipient users as receiving information assets from other users in association with electronic personal data files, the present invention also can permit information assets to be independently acquired by any user and associated to any electronic personal data file generated by the user's communication device, stored in the user's communication device, received from another communication device, or otherwise accessible to the user. For example, the user can associate instructions for a predetermined vibration pattern to an electronic personal data file the user has stored in his electronic address book. The user also can associate instructions to announce a communications request in, for example, the request initiator's own voice. The user could have received the electronic personal data files from another user or generated them himself. Once the user has associated the information asset to an electronic personal data file, the user can send the data file to another communications device or store it in a database of personal data files on his own communications device. In the latter case, the next time the user's communications device receives a communications request having data that matches a signature associated with one of the stored personal data files, the user's communications device can automatically activate the associated information asset. Thus, control over pre-communications interactions can be placed back in the hands of the communications request recipient.

Although particular embodiments of the present invention have been described above in detail, it will be understood that this description is merely for purposes of illustration. Alternative embodiments of those described hereinabove also are within the scope of the present invention. For example, FIGS. 3-7 only present illustrative flowcharts in accordance with some embodiments of the present invention. One or more of the steps described with respect to those figures can be removed or the order of the steps can be changed without departing from the present invention.

Also, each electronic personal data file can be associated with multiple information assets of a single or multiple genres. For example, a personal data file can be associated with a predetermined vibration pattern and a predetermined ringtone. Another personal data file stored in the database can be associated with a different predetermined vibration pattern, a picture, and a link to an audio file stored on a remote server. Other combinations of information assets also can be within the scope of the present invention.

The above described embodiments of the present invention are presented for purposes of illustration and not of limitation, and the present invention is limited only by the claims which follow.

What is claimed is:

1. A communications device comprising:
a communications module for receiving an electronic personal data file from another communications device, wherein the electronic personal data file is associated with a signature and an information asset;
storage for storing the electronic personal data file in a database of electronic personal data files; and
a controller configured to:
determine whether data from an incoming communications request matches the signature; and
automatically activate the information asset responsive to a positive match.

2. The communications device of claim 1, wherein the information asset is configured to cause the communications device to vibrate in a predetermined pattern.

3. The communications device of claim 1, wherein the information asset is configured to cause the communications device to announce a communications request using a user's voice.

4. The communications device of claim 1, wherein the information asset is a link to information stored on a remote server.

5. The communications device of claim 4, wherein the communications module is configured to access the information stored on the remote server.

6. The communications device of claim 5, wherein the communications device is configured to:
download the information stored on the remote server; and
store the downloaded information in storage.

7. The communications device of claim 1, wherein the controller is configured to automatically activate the information asset by presenting information related to the information asset to a communications request recipient.

8. The communications device of claim 1, wherein the controller is configured to automatically activate the information asset by sending the information asset to a central server.

9. A communications device comprising:
a controller configured to:
associate a signature to the electronic personal data file; and
accept user input to associate an information asset to the electronic personal data file, wherein the information asset is configured to cause a recipient communications device to automatically activate the information asset when the recipient communications device receives a communications request having data that matches the signature; and
a communications module for transmitting the electronic personal data file to the recipient communications device for storage in a database of electronic personal data files.

10. The communications device of claim 9, wherein the information asset is configured to cause a communications device to vibrate in a predetermined pattern.

11. The communications device of claim 9, wherein the information asset is configured to cause a communications device to announce a communications request using a user's voice.

12. The communications device of claim 9, wherein the information asset is a link to information stored on a remote server.

13. A communications system comprising:
a first communications device having:
a first controller configured to associate a signature to an electronic personal data file and to accept user input to associate an information asset to the electronic personal data file; and
a first communications module for transmitting the electronic personal data file to a second communications device; and
a second communications device having:
a second communications module for receiving the electronic personal data file; and
a second controller configured to determine whether data from an incoming communications request matches the signature and to automatically activate the information asset responsive to a positive match.

14. The communications system of claim 13, wherein the second controller is configured to automatically activate the information asset by presenting information related to the information asset to a communications request recipient.

15. The communications system of claim 13, further comprising a central server system for facilitating communications between the first and second communications devices.

16. The communications system of claim 15, wherein the second controller is configured to automatically activate the information asset by sending the information asset to the central server system.

17. The communications system of claim 16, wherein the central server system is configured to present information related to the information asset to a communications request initiator.

18. A communications device comprising:
storage for storing a database of electronic personal data files, at least one electronic personal data file having:
an associated signature; and
an associated information asset, wherein the associated information asset is configured to cause a communications device to vibrate in a predetermined pattern;
a communications module for receiving a communications request; and
a controller configured to:
determine whether data from the communications request matches the associated signature; and
automatically activate the associated information asset responsive to a positive match.

19. The communications device of claim 18, wherein the information asset comprises instructions for the communications device to vibrate in a predetermined pattern.

20. The communications device of claim 18, wherein the information asset comprises a link to instructions for the communications device to vibrate in a predetermined pattern.

21. A communications device comprising:
storage for storing a database of electronic personal data files, at least one electronic personal data file having:
an associated signature; and
an associated information asset, wherein the associated information asset is configured to cause a communications device to announce a communications request using a user's voice;
a communications module for receiving a communications request; and
a controller configured to:
determine whether data from the communications request matches the associated signature; and
automatically activate the associated information asset responsive to a positive match.

22. The communications device of claim 21, wherein the information asset is configured to instruct the communications device to use speech synthesis of a user's voice to generate an announcement of the communications request.

23. The communications device of claim 22, wherein the information asset is configured to instruct the controller to:
analyze one or more voice samples recorded during one or more previous communications between a communications request initiator and a communications request recipient, and
generate the announcement based on the one or more voice samples.

24. The communications device of claim 21, wherein the information asset comprises an audio file recorded by a user.

25. The communications device of claim 21, wherein the information asset comprises a link to an announcement a user has recorded and stored on a remote server.
